(19) United States
(12) Patent Application Publication
(10) Pub. No.: US 2026/0336558 A1
(43) Pub. Date: Oct. 29, 2026

(54) GAS GENERATOR

(71) Applicant: DAICEL CORPORATION, Osaka-shi, Osaka (JP)

(72) Inventor: Nobuyuki Katsuda, Tokyo (JP)

(73) Assignee: DAICEL CORPORATION, Osaka-shi, Osaka (JP)

(21) Appl. No.: 19/114,250

(22) PCT Filed: Aug. 31, 2023
(86) PCT No.: PCT/JP2023/031905

§ 371 Date: Mar. 21, 2025

(30) Foreign Application Priority Data
Sep. 22, 2022 (JP) 2022-151374

(51) Int. Cl. B60R 21/264; B60R 21/26

(52) U.S. Cl. CPC B60R 21/264; B60R 2021/26029

(57) ABSTRACT

A gas generator includes a first partition wall part defining, inside an outer shell housing, an ignition chamber and a gas filling chamber, a first communication part provided in the first partition wall part and configured to open by actuation of an igniter, a discharge part provided in the outer shell housing and configured to open by actuation of the igniter, a second partition wall part defining, inside the gas filling chamber, a first filling chamber and a second filling chamber, a fuel gas with which one of the first filling chamber and the second filling chamber is filled and an oxidizing gas with which the other of the first filling chamber and the second filling chamber is filled, and a second communication part provided in the second partition wall part and configured to be closed before actuation of the igniter and to open by actuation of the igniter.

### TECHNICAL FIELD

The present disclosure relates to a gas generator.

### BACKGROUND ART

A typical gas generator is widely known in which a gas source is stored in an accommodating space formed in a housing and gas is released to the outside by actuating an igniter. This type of gas generator is used, for example, to supply gas to an airbag or a seat belt retractor. In this regard, there is disclosed an airbag inflator in which a mixed gas of an oxidizable gas (fuel gas) exemplified by hydrogen gas and an oxidizing gas exemplified by oxygen gas is ignited, generating a combustion gas (water vapor or the like), and the combustion gas is supplied to the airbag as an operating gas, inflating the airbag (for example, Patent Document 1). In the airbag inflator of Patent Document 1, a bottle accommodating the oxidizable gas and a bottle accommodating the oxidizing gas are connected to a common chamber, and seal foils closing outlets of the bottles are ruptured by ignition of squibs, discharging the gas of each bottle into the chamber and igniting a mixed gas thereof.

### Citation List

### Patent Document

Patent Document 1: US 2010/0,283,231 A
Patent Document 2: U.S. Pat. No. 5,582,806
Patent Document 3: JP H09-20203 A

### SUMMARY OF INVENTION

### Technical Problem

An object of the technique according to the present disclosure is to simplify a structure of a gas generator that uses a fuel gas and an oxidizing gas.

### Solution to Problem

### Aspect 1

To solve the above and other problems, a gas generator according to some embodiments of the present disclosure adopts the following configurations. That is, a gas generator according to the present disclosure includes an outer shell housing, an ignition unit including an igniter configured to release a combustion product by actuation, a first partition wall part defining, inside the outer shell housing, an ignition chamber accommodating the ignition unit and a gas filling chamber filled with gas, a first communication part provided in the first partition wall part and configured to be closed before actuation of the igniter and to open by actuation of the igniter and allow the ignition chamber and the gas filling chamber to be in communication with each other, a discharge part provided in the outer shell housing and configured to be closed before actuation of the igniter and to open by actuation of the igniter and allow the gas filling chamber and an outside of the outer shell housing to be in communication with each other, a second partition wall part defining, inside the gas filling chamber, a first filling chamber adjacent to the first communication part and a second filling chamber adjacent to the discharge part, a fuel gas with which one of the first filling chamber and the second filling chamber is filled, an oxidizing gas with which the other of the first filling chamber and the second filling chamber is filled, and a second communication part provided in the second partition wall part and configured to be closed before actuation of the igniter and to open by actuation of the igniter and allow the first filling chamber and the second filling chamber to be in communication with each other.

### Aspect 2

In aspect 1 described above, the igniter and the first communication part may be disposed facing each other.

### Aspect 3

In aspect 1 or 2 described above, the first communication part and the second communication part may be disposed facing each other.

### Aspect 4

In any one of aspects 1 to 3 described above, the second communication part and the discharge part may be disposed facing each other.

### Aspect 5

In any one of aspects 1 to 4 described above, the igniter, the first communication part, the second communication part, and the discharge part may be disposed on an identical straight line.

### Aspect 6

In any one of aspects 1 to 5 described above, the outer shell housing may be formed in a bottomed tubular shape, and the igniter, the first communication part, the second communication part, and the discharge part may be disposed on a center axis of the outer shell housing.

### Aspect 7

The gas generator according to any one of aspects 1 to 6 described above may further include a diffuser housing having a tubular shape, joined to the outer shell housing at an end portion, and forming, inside the diffuser housing, a diffusion chamber to be in communication with the gas filling chamber through the discharge part. A circumferential wall part of the diffuser housing may be formed with a gas discharge hole through which the diffusion chamber and the outside of the gas generator are in communication with each other.

### Aspect 8

In any one of aspects 1 to 7 described above, one of the first filling chamber and the second filling chamber may be filled with the fuel gas together with an inert gas.

### Aspect 9

In any one of aspects 1 to 8 described above, the fuel gas may be hydrogen gas.

### Aspect 10

In aspect 9 described above, a wall surface of one of the first filling chamber and the second filling chamber, whichever is filled with the hydrogen gas, may be coated with a hydrogen-embrittlement resistant film.

### Aspect 11

In any one of aspects 1 to 10 described above, the other of the first filling chamber and the second filling chamber may be filled with the oxidizing gas together with an inert gas.

### Aspect 12

In any one of aspects 1 to 11 described above, the second communication part may be formed as part of the second partition wall part, configured to rupture by actuation of the igniter, and protrude in a dome shape toward the second filling chamber.

### Aspect 13

In aspect 12 described above, the second communication part may be formed thinner than another area of the second partition wall part.

### Aspect 14

In aspect 12 or 13 described above, the second communication part may include a fragile part having a linear shape and formed thinner than another area of the second communication part.

### Aspect 15

In any one of aspects 1 to 14 described above, the ignition unit may include a gas generating agent disposed in the ignition chamber and burned by actuation of the igniter.

### Aspect 16

In any one of aspects 1 to 15 described above, the first communication part may be formed by an opening formed in the first partition wall part, and a rupturable plate configured to close the opening before actuation of the igniter and rupture by actuation of the igniter.

### Aspect 17

In any one of aspects 1 to 5 described above, the discharge part may be formed by an opening formed in the outer shell housing and a rupturable plate configured to close the opening before actuation of the igniter and rupture by actuation of the igniter.

### Aspect 18

In any one of aspects 1 to 17 described above, the outer shell housing may be formed in a bottomed tubular shape, the first filling chamber may include a first axial direction region adjacent to the ignition chamber in an axial direction of the outer shell housing with the first partition wall part interposed between the first axial direction region and the ignition chamber, and a first radial direction region having a tubular shape surrounding the ignition chamber from a radial direction of the outer shell housing with the first partition wall part interposed between the first radial direction region and the ignition chamber; and the second filling chamber may include a second axial direction region adjacent to the first axial direction region of the first filling chamber in the axial direction of the outer shell housing with the second partition wall part interposed between the second axial direction region and the first axial direction region, and a second radial direction region having a tubular shape surrounding the first radial direction region of the first filling chamber from the radial direction of the outer shell housing with the second partition wall part interposed between the second radial direction region and the first radial direction region.

### Aspect 19

The gas generator in any one of aspects 1 to 18 described above may further include a diffuser housing having a tubular shape, joined to the outer shell housing at an end portion, and forming, inside the diffuser housing, a diffusion chamber to be in communication with the gas filling chamber through the discharge part, a circumferential wall part of the diffuser housing may be formed with a gas discharge hole through which the diffusion chamber and the outside of the gas generator are in communication with each other, the diffusion chamber may be adjacent to the gas filling chamber in the axial direction of the outer shell housing with a wall of the outer shell housing interposed between the diffusion chamber and the gas filling chamber, and a gas generator housing configured by the outer shell housing and the diffuser housing may have a length in the axial direction shorter than a width in the radial direction.

### Advantageous Effects of Invention

According to some embodiments of the present disclosure, it is possible to simplify a structure of a gas generator that uses a fuel gas and an oxidizing gas.

### BRIEF DESCRIPTION OF DRAWINGS

FIG. 1 is a cross-sectional view illustrating a state before actuation of a gas generator according to an embodiment.

FIG. 2 is a diagram for describing a second communication part according to an embodiment.

FIG. 3 is a diagram for describing a modified example of the second communication part.

FIG. 4 is a cross-sectional view illustrating a state at the time of actuation of a gas generator according to an embodiment.

### DESCRIPTION OF EMBODIMENTS

Embodiments according to the present disclosure will be described below with reference to the accompanying drawings. In the following embodiment, an aspect where a technique according to an embodiment of the present disclosure is applied to a gas generator for an airbag (inflater) will be described. However, the application of the technique according to the present disclosure is not limited thereto. For example, the technique may be applied to a gas generator for a seat belt retractor. Note that the respective configurations and the combinations thereof in the respective embodiments are merely examples, and additions, omissions, substitutions, and other changes to the configurations can be made as appropriate without departing from the gist of the present invention. The present disclosure is not limited by the embodiments, but only limited by the claims.

### Overall Configuration

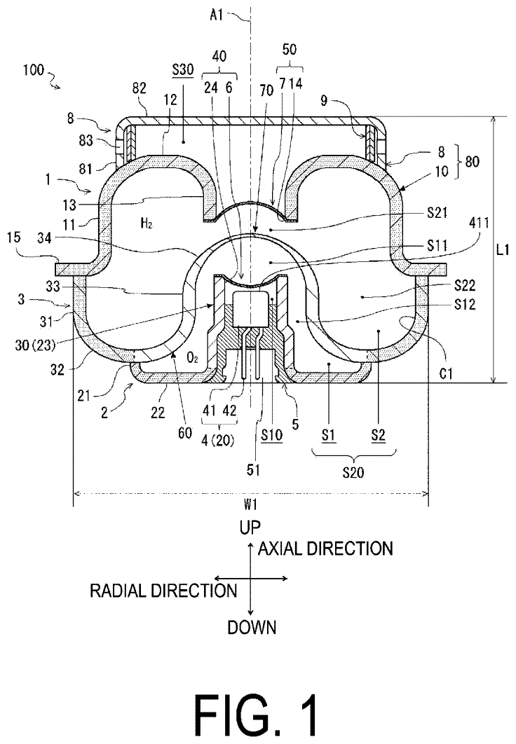

FIG. 1 is a cross-sectional view illustrating a state before actuation of a gas generator 100 according to an embodiment. FIG. 1 illustrates a cross section in an axial direction of an outer shell housing denoted by reference sign 10. The gas generator 100 is an airbag inflator, and is a device that supplies an airbag (not illustrated) with an operating gas that inflates the airbag at the time of actuation. The gas generator 100 is configured to ignite a mixed gas of hydrogen gas, which is an example of a fuel gas, and oxygen gas, which is an example of an oxidizing gas, thereby generating water vapor, which is a combustion gas, and to supply the water vapor to the airbag as a gas for airbag actuation (hereinafter referred to as operating gas).

As illustrated in FIG. 1, the gas generator 100 includes an upper shell 1, a lower shell 2, an intermediate shell 3, an ignition unit 20, a holding member 5, a first rupturable plate 6, a second rupturable plate 7, a diffuser housing 8, and a filter 9, and is formed in a bottomed tubular shape with both end portions closed. Further, although details will be described below, the outer shell housing 10 indicated by a dot pattern in FIG. 1 is formed by the upper shell 1, part of the lower shell 2, and part of the intermediate shell 3. The outer shell housing 10 is formed in a bottomed tubular shape with both end portions closed. Reference sign A1 in FIG. 1 denotes a center axis of the outer shell housing 10. Hereinafter, a direction in the axial direction of the outer shell housing 10 is defined as a vertical direction of the gas generator 100, the lower shell 2 side (that is, lower side in FIG. 1) is defined as a lower side of the gas generator 100, and a side opposite thereto (that is, upper side in FIG. 1 that is the upper shell 1) is defined as an upper side of the gas generator 100. Further, in the following description, unless otherwise specified, “axial direction” refers to the axial direction of the outer shell housing 10, “radial direction” refers to a radial direction of the outer shell housing 10, and “circumferential direction” refers to a circumferential direction of the outer shell housing 10. Hereinafter, components of the gas generator 100 will be described.

### Upper Shell, Lower Shell, and Intermediate Shell

The upper shell 1 includes an upper outer circumferential wall part 11, a top plate part 12, an upper inner circumferential wall part 13, and a flange part 15, and is formed in a bottomed tubular shape with an upper end portion closed. The upper outer circumferential wall part 11 is formed in a tubular shape extending vertically. The top plate part 12 extends inward in the radial direction from an upper end portion of the upper outer circumferential wall part 11. The upper inner circumferential wall part 13 is formed in a tubular shape extending (protruding) downward from an edge portion of the top plate part 12 inward in the radial direction. An opening 14 is formed in a lower end portion of the upper inner circumferential wall part 13. The flange part 15 extends outward in the radial direction from a lower end portion of the upper outer circumferential wall part 11.

The lower shell 2 includes a lower outer circumferential wall part 21, a bottom plate part 22, and a lower inner circumferential wall part 23, and is formed in a bottomed tubular shape with a lower end portion closed. The lower outer circumferential wall part 21 is formed in a tubular shape extending vertically. The bottom plate part 22 extends inward in the radial direction from a lower end portion of the lower outer circumferential wall part 21. The lower inner circumferential wall part 23 is formed in a tubular shape extending (protruding) upward from an edge portion of the bottom plate part 22 inward in the radial direction. An opening 24 is formed in an upper end portion of the lower inner circumferential wall part 23.

The intermediate shell 3 includes an intermediate outer circumferential wall part 31, an intermediate plate part 32, an intermediate inner circumferential wall part 33, and a lid wall part 34, and is formed in a bottomed tubular shape with a lower end portion closed. The intermediate outer circumferential wall part 31 is formed in a tubular shape extending vertically. The intermediate plate part 32 extends inward in the radial direction from a lower end portion of the intermediate outer circumferential wall part 31. The intermediate inner circumferential wall part 33 is formed in a tubular shape extending (protruding) upward from an edge portion of the intermediate plate part 32 inward in the radial direction. The lid wall part 34 closes an upper end portion of the intermediate inner circumferential wall part 33.

As illustrated in FIG. 1, the upper outer circumferential wall part 11 and the upper inner circumferential wall part 13 of the upper shell 1, the lower outer circumferential wall part 21 and the lower inner circumferential wall part 23 of the lower shell 2, and the intermediate outer circumferential wall part 31 and the intermediate plate part 32 of the intermediate shell 3 are disposed coaxially with the center axis A1 of the outer shell housing 10.

The upper shell 1, the lower shell 2, and the intermediate shell 3 are formed of a metal material. The metal material forming these is not particularly limited, but iron, stainless steel, and the like are exemplified. As illustrated in FIG. 1, the upper shell 1 is disposed on the upper side, the lower shell 2 is disposed on the lower side, and the intermediate shell 3 is disposed between the upper shell 1 and the lower shell 2. The lower inner circumferential wall part 23 of the lower shell 2 is inserted into the intermediate inner circumferential wall part 33 of the intermediate shell 3 and, in this state, the flange part 15 of the upper shell 1 and the intermediate outer circumferential wall part 31 of the intermediate shell 3 are joined to each other, and the intermediate plate part 32 of the intermediate shell 3 and the lower outer circumferential wall part 21 of the lower shell 2 are joined to each other. To join the members, laser welding, for example, can be used.

### First Rupturable Plate

The first rupturable plate 6 is a plate-like member that closes the opening 24 of the lower shell 2 by covering the opening 24, and is configured to rupture by energy generated by actuation of an igniter 4. The first rupturable plate 6 is formed of a metal material. The metal material forming the first rupturable plate 6 is not particularly limited, but iron, stainless steel, and the like are exemplified. The first rupturable plate 6 is fixed to the lower inner circumferential wall part 23 by a circumferential edge portion thereof being joined to the upper end portion of the lower inner circumferential wall part 23 by laser welding or the like.

### Second Rupturable Plate

The second rupturable plate 7 is a plate-like member that closes the opening 14 of the upper shell 1 by covering the opening 14, and is configured to rupture by energy generated by actuation of the igniter 4. As with the first rupturable plate 6, the second rupturable plate 7 is formed of a metal material exemplified by iron, stainless steel, and the like. The second rupturable plate 7 is fixed to the upper inner circumferential wall part 13 by a circumferential edge portion thereof being joined to the lower end portion of the upper inner circumferential wall part 13 by laser welding or the like.

### Outer Shell Housing

The outer shell housing 10 is formed by the upper shell 1, the lower outer circumferential wall part 21 and the bottom plate part 22 of the lower shell 2, and the intermediate outer circumferential wall part 31 and part of the intermediate plate part 32 of the intermediate shell 3. More specifically, an area of the intermediate plate part 32 that is outward of a joining part with the lower outer circumferential wall part 21 of the lower shell 2 in the radial direction constitutes part of the outer shell housing 10.

### First Partition Wall Part

As illustrated in FIG. 1, an internal space of the outer shell housing 10 is partitioned by a first partition wall part 30. The first partition wall part 30 is formed by part of the lower inner circumferential wall part 23 of the lower shell 2. An ignition chamber S10 accommodating the ignition unit 20 and a gas filling chamber S20 filled with gas are defined inside the outer shell housing 10 by the first partition wall part 30. The ignition chamber S10 is a space surrounded by the first partition wall part 30 in the internal space of the outer shell housing 10, and is maintained at atmospheric pressure by a first communication part 40 described below being closed. The gas filling chamber S20 is a space outside the first partition wall part 30 in the internal space of the outer shell housing 10, and is in a pressurized state by being filled with pressurized gas.

### Ignition Unit

The ignition unit 20 includes the igniter 4 accommodated in the ignition chamber S10. The igniter 4 includes an ignition part 41 accommodating an ignition charge, and a conductive part 42 supplied with an ignition current for igniting the ignition charge. The igniter 4 is configured to be actuated by the ignition current supplied to the conductive part 42 and thus rupture the ignition part 41 and release a combustion product (flame and the like) of the ignition charge. Reference sign 411 in FIG. 1 denotes a release part that ruptures upon actuation of the igniter 4 and releases the combustion product. The release part 411 faces upward.

Here, examples of the ignition charge used in the igniter 4, while not limited, include an explosive containing zirconium and potassium perchlorate (ZPP), an explosive containing titanium hydride and potassium perchlorate (THPP), an explosive containing titanium and potassium perchlorate (TiPP), an explosive containing aluminum and potassium perchlorate (APP), an explosive containing aluminum and bismuth oxide (ABO), an explosive containing aluminum and molybdenum oxide (AMO), an explosive containing aluminum and copper oxide (ACO), an explosive containing aluminum and ferric oxide (AFO), and an explosive composed of a combination of a plurality of these explosives.

The ignition unit 20 may further contain a solid gas generating agent in accordance with the energy required for rupture of communication parts and a discharge part described below. The gas generating agent is accommodated in the ignition chamber S10 and generates gas by being burned by the combustion product released from the igniter 4 when the igniter 4 is actuated. Further, the gas generating agent can be disposed adjacent to the ignition charge inside the ignition part 41. As the gas generating agent, for example, an agent having a single-perforated columnar shape consisting of guanidine nitrate (41 wt. %), basic copper nitrate (49 wt. %), and a binder or an additive can be used. However, the gas generating agent is not limited thereto.

Here, the “energy generated by actuation of the igniter” in this example includes energy released from the igniter 4 (shock wave, flame, high-temperature gas, and the like due to the release of the combustion product) and energy due to the combustion of the ignition charge (pressure rise and the like). In a case in which the ignition unit 20 includes a gas generating agent, energy due to combustion of the gas generating agent caused by actuation of the igniter 4 (pressure rise or the like) is also included in the “energy generated by actuation of the igniter.” That is, in the present specification, the “energy generated by actuation of the igniter” refers to energy primarily or secondarily generated by actuation of the igniter.

### Holding Member

The holding member 5 is a resin member that is disposed between the igniter 4 and the lower inner circumferential wall part 23 of the lower shell 2 and integrally joins the igniter 4 and the lower inner circumferential wall part 23. An annular gap formed between the igniter 4 and the lower inner circumferential wall part 23 is filled by the holding member 5. Thus, the internal space of the ignition chamber S10 is sealed. The holding member 5 covers the igniter 4 while exposing the release part 411 of the igniter 4 from the holding member 5 to the ignition chamber S10 and exposing a distal end portion of the conductive part 42 from the holding member 5 to an external space of the outer shell housing 10. Further, the holding member 5 covers an inner circumferential surface of the lower inner circumferential wall part 23, forming a connector insertion space 51 into which a power supply connector (not illustrated) can be inserted inside the lower inner circumferential wall part 23.

### First Communication Part

The first partition wall part 30 is provided with the first communication part 40 configured to be closed before actuation of the igniter 4 and to open by actuation of the igniter 4 and allow the ignition chamber S10 and the gas filling chamber S20 (more specifically, a first filling chamber S1) to be in communication with each other. The first communication part 40 is formed by the opening 24 formed in the first partition wall part 30 and the first rupturable plate 6 closing the opening 24. The opening 24 is closed by the first rupturable plate 6 before actuation of the igniter 4 and, when the igniter 4 is actuated, the first rupturable plate 6 is ruptured by receiving energy generated by the actuation of the igniter 4, thereby opening the first communication part 40 and allowing the ignition chamber S10 and the gas filling chamber S20 to be in communication with each other. Before actuation of the igniter 4, the first communication part 40 is closed, and thus the ignition chamber S10 is maintained at atmospheric pressure and the igniter 4 is prevented from being exposed to the pressurized gas.

As illustrated in FIG. 1, in this example, the release part 411 of the igniter 4 and the first communication part 40 are disposed facing each other. Therefore, upon actuation of the igniter 4, energy (shock wave, flame, high-temperature gas, or the like) is released from the igniter 4 toward the first rupturable plate 6, facilitating rupture of the first rupturable plate 6.

### Discharge Part

The outer shell housing 10 is provided with a discharge part 50 configured to be closed before actuation of the igniter 4 and to open by actuation of the igniter 4 and allow the gas filling chamber S20 (more specifically, a second filling chamber S2) and the outside of the outer shell housing 10 (more specifically, a diffusion chamber S30) to be in communication with each other. The discharge part 50 is formed by the opening 14 formed in the outer shell housing 10 and the second rupturable plate 7 that closes the opening 14. The opening 14 is closed by the second rupturable plate 7 before actuation of the igniter 4 and, when the igniter 4 is actuated, the second rupturable plate 7 is ruptured by receiving energy generated by actuation of the igniter 4, thereby opening the discharge part 50 and allowing the gas filling chamber S20 and the outside of the outer shell housing 10 to be in communication with each other.

### Second Partition Wall Part

As illustrated in FIG. 1, the gas filling chamber S20 is partitioned by a second partition wall part 60. The second partition wall part 60 is formed by part of the intermediate plate part 32, the intermediate inner circumferential wall part 33, and the lid wall part 34 of the intermediate shell 3. More specifically, an area of the intermediate plate part 32 that is inward in the radial direction of the joining part with the lower outer circumferential wall part 21 of the lower shell 2 constitutes part of the second partition wall part 60. Inside the gas filling chamber S20, the first filling chamber S1 adjacent to the first communication part 40 and the second filling chamber S2 adjacent to the discharge part 50 are defined by the second partition wall part 60. The first filling chamber S1 is a space surrounded by the second partition wall part 60 in the gas filling chamber S20, and is defined by the lower shell 2 and the intermediate shell 3. The second filling chamber S2 is a space outside the second partition wall part 60 in the gas filling chamber S20, and is defined by the upper shell 1 and the intermediate shell 3.

### Second Communication Part

The second partition wall part 60 is provided with a second communication part 70 configured to be closed before actuation of the igniter 4 and to open by actuation of the igniter 4 and allow the first filling chamber S1 and the second filling chamber S2 to be in communication with each other. The second communication part 70 is formed as part of the second partition wall part 60, and is thus ruptured by actuation of the igniter 4. More specifically, the second communication part 70 is formed by a center portion of the lid wall part 34 constituting the second partition wall part 60, and protrudes in a dome shape toward the second filling chamber S2. Communication between the first filling chamber S1 and the second filling chamber S2 is blocked before actuation of the igniter 4 and, when the igniter 4 is actuated, the center portion of the lid wall part 34 ruptures by receiving energy generated by actuation of the igniter 4, opening the second communication part 70 and allowing the first filling chamber S1 and the second filling chamber S2 to be in communication with each other.

As illustrated in FIG. 1, in this example, the first communication part 40 and the second communication part 70 are disposed facing each other. Therefore, upon actuation of the igniter 4, energy (shock wave, high-temperature gas, and the like) is released from the opened first communication part 40 toward the second communication part 70, facilitating rupture of the second communication part 70.

Here, the second communication part 70 protrudes toward the second filling chamber S2. That is, the second communication part 70 protrudes outside the first filling chamber S1. Therefore, a strength of the second communication part 70 against the energy from the first filling chamber S2 side is low as compared with a strength thereof against the energy from the second filling chamber S1 side. This also facilitates the rupture of the second communication part 70 upon actuation of the igniter 4.

The advantages of forming the second communication part 70 in a dome shape include the following. During manufacture of the gas generator 100, one of the first filling chamber S1 and the second filling chamber S2 is filled with pressurized gas, and subsequently the other is filled with pressurized gas. At this time, from the viewpoint of strength against the pressurized gas, repeated recessing and protruding deformations are not preferred, such as when the pressure of the pressurized gas with which one filling chamber is initially filled causes the second communication part 70 to deform in a protruding shape toward the other filling chamber, and subsequently the pressure of the pressurized gas with which the other filling chamber is filled pushes back and causes the second communication part 70 to deform in a protruding shape toward the first filling chamber. In contrast, in this example, the second communication part 70 is formed in advance in a dome shape protruding toward the second filling chamber S2, and thus the second communication part 70 is less likely to deform in response to a rise in pressure in the second filling chamber S2. Therefore, not only when the first filling chamber S1 is first filled with the pressurized gas but also when the second filling chamber S2 is first filled with the pressurized gas, deformation of the second communication part 70 in a protruding shape toward the first filling chamber S1 is suppressed. That is, at least deformation in a protruding shape toward the first filling chamber S1 is suppressed. Accordingly, with the second communication part 70 being formed in a dome shape, repeated recessing and protruding deformations of the second communication part 70 upon filling with the pressurized gas are prevented.

Furthermore, the second communication part 70 is formed thinner than other areas of the second partition wall part 60 (that is, areas of the second partition wall part 60 other than the second communication part 70). Therefore, the second communication part 70 is weaker than the other areas of the second partition wall part 60. This also facilitates the rupture of the second communication part 70 upon actuation of the igniter 4.

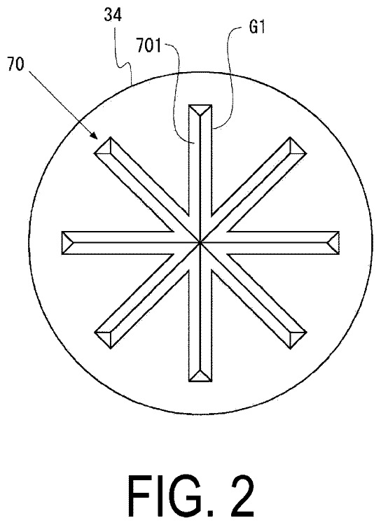

FIG. 2 is a diagram for describing the second communication part 70 according to an embodiment. FIG. 2 illustrates an upper end surface of the lid wall part 34 of the intermediate shell 3. As illustrated in FIG. 2, a plurality of grooves G1 having a V shape (triangular shape in a cross section) extending linearly are formed in the second communication part 70. The plurality of grooves G1 extend radially in the radial direction starting from a center portion serving as a top portion of the lid wall part 34. As illustrated in FIG. 2, eight grooves G1 are formed at equal angular intervals in this example. However, the technique according to the present disclosure is not limited to such a configuration. Further, the shape of the groove G1 is not limited to the V shape, and the cross section may be quadrangular or semi-circular.

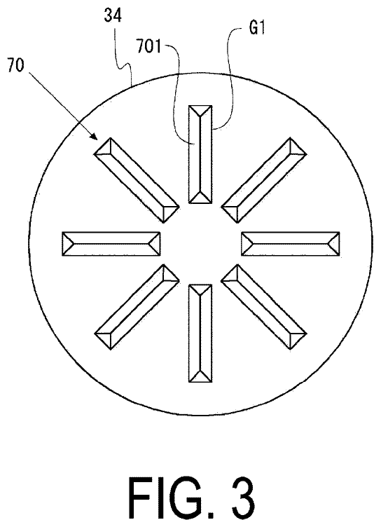

An area of the second communication part 70 where the groove G1 is formed is a fragile part 701 having a linear shape and formed thinner than the other areas of the second communication part 70. The fragile part 701 is more fragile than other areas (that is, areas of the second communication part 70 other than the fragile part 701), and readily breaks. The second communication part 70, by including the fragile part 701 that has a linear shape and preferentially readily ruptures, readily ruptures upon actuation of the igniter 4 while ensuring the strength against the pressurized gas. In this example, a plurality of the fragile parts 701 are formed, and all of the fragile parts 701 intersect at a center of the second communication part 70. Note that, because the strength of the portion where the fragile parts 701 intersect is particularly reduced, in consideration of the strength against the pressurized gas, only some of the fragile parts 701 may intersect or a mode may be adopted in which none of the fragile parts 701 intersect. Further, the intersecting portion of the grooves G1 may be formed shallower. FIG. 3 is a diagram for describing a modified example of the second communication part 70. As illustrated in FIG. 3, in the second communication part 70 according to the modified example, the fragile parts 701 do not intersect at the center portion thereof. That is, the fragile parts 701 are formed in an area excluding the center portion (top portion) of the second communication part 70. Note that the second communication part 70 illustrated in FIG. 2 and FIG. 3 includes the plurality of (eight) fragile parts 701, but the number of the fragile parts 701 need not be plural and may be one. Further, the fragile part 701 of this example is formed in a solid line shape that extends continuously, but the fragile part 701 may be formed in a broken line shape or a dotted line shape that extends intermittently.

As illustrated in FIG. 1, in this example, the second communication part 70 and the discharge part 50 are disposed facing each other. Therefore, upon actuation of the igniter 4, energy (shock wave, high-temperature gas, and the like) is released from the opened second communication part 70 toward the second rupturable plate 7, and the second rupturable plate 7 readily ruptures.

### First Filling Chamber

The first filling chamber S1 includes a first axial direction region S11 and a first radial direction region S12. The first axial direction region S11 is adjacent to the ignition chamber S10 in the axial direction with the first partition wall part 30 interposed therebetween, and is disposed above the ignition chamber S10. The first axial direction region S11 is interposed between the first communication part 40 and the second communication part 70 in the axial direction. The first radial direction region S12 is formed in a tubular shape surrounding the ignition chamber S10 in the radial direction with the first partition wall part 30 interposed therebetween, and is disposed outward of the ignition chamber S10 in the radial direction.

### Second Filling Chamber

The second filling chamber S2 includes a second axial direction region S21 and a second radial direction region S22. The second axial direction region S21 is adjacent to the first axial direction region S11 of the first filling chamber S1 in the axial direction with the second partition wall part 60 interposed therebetween, and is disposed above the first axial direction region S11. The second axial direction region S21 is interposed between the second communication part 70 and the discharge part 50 in the axial direction. The second radial direction region S22 is formed in a tubular shape surrounding the first radial direction region S12 in the radial direction of the first filling chamber S1 with the second partition wall part 60 interposed therebetween, and is disposed outward in the radial direction of the first radial direction region S12.

### Gas

The second filling chamber S2 is filled with a singular gas of hydrogen as the fuel gas in a compressed state. However, the fuel gas according to the present disclosure is not limited to hydrogen gas. The fuel gas is not particularly limited, and examples thereof include a combustible gas such as a singular gas of hydrogen, methane, ethane, propane, or butane, and a mixed gas containing at least one of these gases.

Further, the first filling chamber S1 is filled with a singular gas of oxygen as the oxidizing gas in a compressed state. However, the oxidizing gas according to the present disclosure is not limited to oxygen gas. The oxidizing gas is not particularly limited, and examples thereof include combustion assisting gases such as a singular gas such as oxygen or nitrous oxide, and a mixed gas such as air.

Note that, in the gas generator according to the present disclosure, the first filling chamber may be filled with the fuel gas, and the second filling chamber may be filled with the oxidizing gas. That is, in the gas generator according to the present disclosure, one of the first filling chamber and the second filling chamber need only be filled with the fuel gas and the other need only be filled with the oxidizing gas. Further, the gas with which the filling chamber is filled need not be in a pressurized state.

Further, one of the first filling chamber and the second filling chamber may be filled with the fuel gas together with an inert gas. Further, the other of the first filling chamber and the second filling chamber may be filled with the oxidizing gas together with an inert gas. That is, in this example, the second filling chamber S2 may be filled with hydrogen gas and an inert gas, and the first filling chamber S1 may be filled with oxygen gas and an inert gas. By allowing the fuel gas and the oxidizing gas to coexist with an inert gas, it is possible to lower and control a combustion temperature of the mixed gas. Note that the pressurized state of the filling chamber may be formed by an inert gas. The inert gas is not particularly limited, and examples thereof include gases having low reactivity such as nitrogen, argon, helium, and carbon dioxide.

### Hydrogen-Embrittlement Resistant Film

Wall surfaces of the second filling chamber S2 filled with hydrogen gas are coated with a hydrogen-embrittlement resistant film C1 formed of a material having hydrogen-blocking properties and thus preventing hydrogen-embrittlement caused by the metal surfaces constituting the wall surfaces coming into contact with hydrogen. The hydrogen-embrittlement resistant film C1 is provided on the surfaces defining the second filling chamber S2 in the upper shell 1 and the intermediate shell 3. This hydrogen-embrittlement resistant film C1 need only be configured to be capable of suppressing the penetration of hydrogen into the metal surfaces. A material of the hydrogen-embrittlement resistant film C1, as long as having hydrogen-blocking properties, is not limited, and may be a resin material, a metal material, or a ceramic material.

The resin material forming the hydrogen-embrittlement resistant film C1 is exemplified by ethylene vinyl alcohol copolymer resins and polyamide 6, the metal material is exemplified by A6061-T6 aluminum alloy, and the ceramic material is exemplified by aluminum oxides and titanium oxides. Specific examples of the configuration of the hydrogen-embrittlement resistant film C1 include the Al-5Mg thermal spray coating described in JP 2018-141214 A, the coatings having relatively high hydrogen cutoff described in Table 1 of JP 2021-139034 A, and the ceramic thin film described in JP 2007-9276 A.

Note that, in this example, the wall surfaces of the second filling chamber $2 are coated with the hydrogen-embrittlement resistant film C1. However, in a case in which the first filling chamber S1 is filled with hydrogen gas, the wall surfaces of the first filling chamber C1 are coated with the hydrogen-embrittlement resistant film S1. That is, the hydrogen-embrittlement resistant film C1 need only be coated on the wall surfaces of one of the first filling chamber S1 and the second filling chamber S2, whichever is filled with hydrogen gas. However, in the gas generator according to the present disclosure, the hydrogen-embrittlement resistant film is not an essential component.

### Diffuser Housing

The diffuser housing 8 is formed in a bottomed tubular shape extending vertically with a closed upper end portion. More specifically, the diffuser housing 8 includes a circumferential wall part 81 having a tubular shape extending vertically and a lid wall part 82 that closes an upper end portion of the circumferential wall part 81. A lower end portion (corresponding to one end portion of the diffuser housing according to the present disclosure) of the circumferential wall part 81 is joined to the outer shell housing 10, positioning the discharge part 50 of the outer shell housing 10 inside the circumferential wall part 81. Thus, the diffusion chamber S30 to be in communication with the gas filling chamber S20 through the discharge part 50 is formed inside the diffuser housing 8.

The circumferential wall part 81 of the diffuser housing 8 is formed with a plurality of gas discharge holes 83 that allow the diffusion chamber S30 and the outside of the gas generator 100 to be in communication with each other. When the igniter 4 is actuated, the operating gas from the gas filling chamber S20 passes through the diffusion chamber S30 and is released to the outside through the gas discharge holes 83. Note that the number of the gas discharge holes 83 is not particularly limited and need not be plural.

### Filter

The filter 9 is a member having a tubular shape, extending vertically, and open at both end portions, and is disposed between the discharge part 50 and the gas discharge holes 83 inside the diffusion chamber S30 in a state in which an upper end portion thereof is supported by the lid wall part 82 of the diffuser housing 8 and a lower end portion thereof is supported by the top plate part 12 of the upper shell 1. Pores are formed in the filter 9, facilitating filtration and cooling of the operating gas.

### Arrangement of Igniter, Communication Parts, and Discharge Part

As illustrated in FIG. 1, in this example, the igniter 4, the first communication part 40, the second communication part 70, and the discharge part 50 are disposed on the same straight line. Here, a plurality of members being “disposed on the same straight line” means that a straight line passing through the plurality of members may exist. In this example, as the same straight line, the center axis A1 of the outer shell housing 10 passes through the igniter 4, the first communication part 40, the second communication part 70, and the discharge part 50. That is, the igniter 4, the first communication part 40, the second communication part 70, and the discharge part 50 are disposed on the center axis A1.

The igniter 4, the first communication part 40, the second communication part 70, and the discharge part 50 being disposed on the same straight line means that the first communication part 40, the second communication part 70, and the discharge part 50 are linearly aligned in a direction in which the combustion product is discharged from the release part 411 of the igniter 4 (upward direction in this example). This makes it easy to open the first communication part 40, the second communication part 70, and the discharge part 50 all together by energy (shock wave, flame, high-temperature gas, or the like) released from the igniter 4 upon actuation of the igniter 4. That is, this makes it easy to open all of the first communication part 40, the second communication part 70, and the discharge part 50 with one igniter. Further, with the path from the igniter 4 to the diffusion chamber S30 being linear, the combustion product released from the igniter 4 readily reaches the diffusion chamber S30, and the mixed gas in the diffusion chamber S30 is readily ignited. Furthermore, in the gas generator 100 according to the present embodiment, the igniter 4, the first communication part 40, the second communication part 70, and the discharge part 50 are disposed close to each other in the axial direction (vertical direction), further facilitating the opening of all of these.

Further, with the igniter 4, the first communication part 40, the second communication part 70, and the discharge part 50 being disposed on the center axis A1 of the outer shell housing 10, the gas generator 100 can adopt an axisymmetric structure with respect to the center axis A1. This makes it easy to manufacture the gas generator 100. Further, by making the gas generator 100 axisymmetric in structure, it is possible to suppress output unevenness of the gas generator in the circumferential direction.

### Operation

Next, the operation of the gas generator 100 according to an embodiment will be described. In a state illustrated in FIG. 1 in which the gas generator 100 is attached to a vehicle before actuation, a connector (not illustrated) inserted into the connector insertion space 51 is connected to the conductive part 42 of the igniter 4, and power can be supplied to the igniter 4. In this state, when a sensor (not illustrated) mounted on the automobile detects an impact, power from an external power source (not illustrated) is supplied to the conductive part 42 via the connector, actuating the igniter 4 and burning the ignition charge in the ignition part 41.

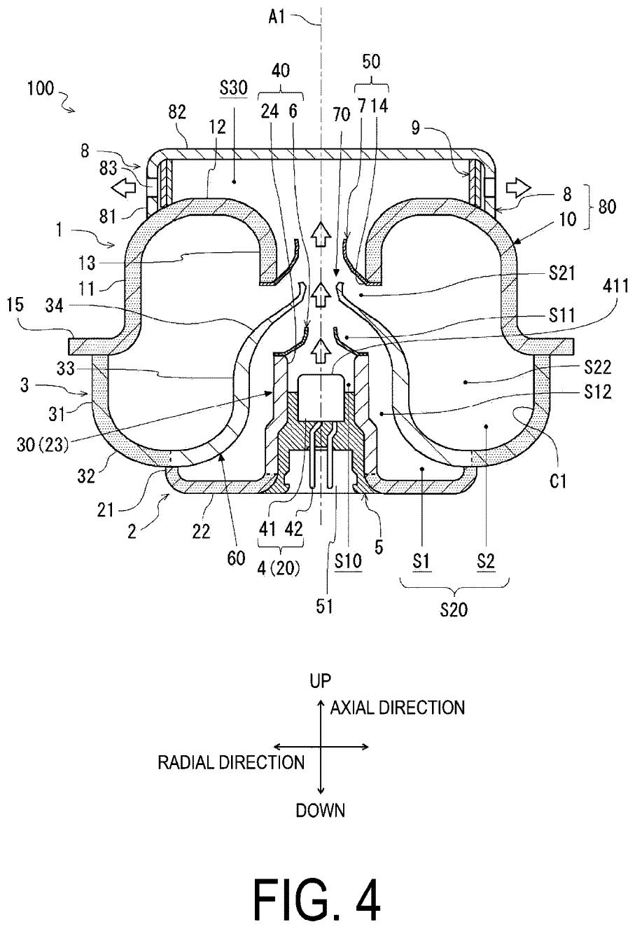

FIG. 4 is a cross-sectional view illustrating a state at the time of actuation of the gas generator 100 according to an embodiment. FIG. 4 illustrates a cross section in the axial direction of the outer shell housing 10. When the igniter 4 is actuated and the internal pressure of the ignition part 41 rises with the combustion of the ignition charge, the release part 411 ruptures and the combustion product of the ignition charge is released into the ignition chamber S10. At this time, the combustion product is released in the upward direction (axial direction). The first communication part 40 is disposed above the igniter 4, facing the release part 411 of the igniter 4, and thus, as illustrated in FIG. 4, the first rupturable plate 6 of the first communication part 40 ruptures upon receipt of the energy (shock wave, flame, high-temperature gas, or the like) released from the igniter 4. As a result, the first communication part 40 opens. Further, the second communication part 70 is disposed above the first communication part 40, facing the first communication part 40, and thus the second communication part 70 ruptures upon receipt of the energy released from the opened first communication part 40. As a result, the second communication part 70 opens. Furthermore, the discharge part 50 is disposed above the second communication part 70, facing the second communication part 70, and thus the second rupturable plate 7 of the discharge part 50 ruptures upon receipt of the energy released from the opened second communication part 70. As a result, the discharge part 50 opens. Thus, since the igniter 4, the first communication part 40, the second communication part 70, and the discharge part 50 are disposed on the same straight line, they open all together by the energy released from the igniter 4.

With the opening of the second communication part 70 provided in the second partition wall part 60 partitioning the first filling chamber S1 and the second filling chamber S2, the oxygen gas (oxidizing gas) with which the first filling chamber S1 is filled and the hydrogen gas (fuel gas) with which the second filling chamber S2 is filled can be mixed. The oxygen gas flows into the diffusion chamber S30 through the second communication part 70 and the discharge part 50 and diffuses therein. The hydrogen gas flows into the diffusion chamber S30 through the discharge part 50 and diffuses therein. As a result, the oxygen gas and the hydrogen gas are mixed in the diffusion chamber S30. Then, the combustion product discharged from the igniter 4 flows into the diffusion chamber S30 through the first communication part 40, the second communication part 70, and the discharge part 50, igniting and burning the mixed gas of hydrogen gas and oxygen gas. As a result, water vapor, which is the operating gas of the airbag, is generated.

The operating gas generated in the diffusion chamber S30 passes through the filter 9 and is discharged from the gas discharge holes 83 to outside the gas generator 100. While the operating gas passes through the filter 9, fragments of the first rupturable plate 6, the second rupturable plate 7, and the lid wall part 34 contained in the gas are captured by the filter 9. Further, the operating gas, when passing through the filter 9, is cooled and filtered by the filter 9. Then, with the gas discharge holes 83 being formed in the circumferential wall part 81 of the diffuser housing 8, the operating gas is released outward in the radial direction. Accordingly, the flow of gas which has been in the axial direction from the gas filling chamber S20 to the diffusion chamber S30 is changed to the radial direction by the diffuser housing 8.

The operating gas discharged from the gas generator 100 is supplied to the airbag, inflating the airbag to protect an occupant of the vehicle from the impact.

### Actions and Effects

As described above, a gas generator 100 according to the present embodiment includes:
an outer shell housing 10;
an ignition unit 20 including an igniter 4 configured to release a combustion product by actuation;
a first partition wall part 30 defining, inside the outer shell housing 10, an ignition chamber S10 accommodating the ignition unit 20 and a gas filling chamber S20 filled with gas;
a first communication part 40 provided in the first partition wall part 30 and configured to be closed before actuation of the igniter 4 and to open by actuation of the igniter 4 and allow the ignition chamber S10 and the gas filling chamber S20 to be in communication with each other;
a discharge part 50 provided in the outer shell housing 10 and configured to be closed before actuation of the igniter 4 and to open by actuation of the igniter 4 and allow the gas filling chamber S20 and an outside of the outer shell housing 10 to be in communication with each other;
a second partition wall part 60 defining, inside the gas filling chamber S20, a first filling chamber S1 adjacent to the first communication part 40 and a second filling chamber S2 adjacent to the discharge part 50;
hydrogen gas with which one of the first filling chamber S1 and the second filling chamber S2 (second filling chamber S2 in this example) is filled, as a fuel gas;
oxygen gas with which the other of the first filling chamber S1 and the second filling chamber S2 (first filling chamber S1 in this example) is filled, as an oxidizing gas; and
a second communication part 70 provided in the second partition wall part 60 and configured to be closed before actuation of the igniter 4 and to open by actuation of the igniter 4 and allow the first filling chamber S1 and the second filling chamber S2 to be in communication with each other.

That is, the gas generator 100 adopts a structure in which the second communication part 70 provided in the second partition wall part 60 partitioning the first filling chamber S1 and the second filling chamber S2 is opened by actuation of the igniter 4, thereby mixing the fuel gas and the oxidizing gas. This makes it possible to mix the fuel gas and the oxidizing gas by the single igniter 4. Therefore, the gas generator 100 according to the present embodiment can reduce the number of components and simplify the structure as compared with a gas generator having a structure in which gases are mixed in a chamber by filling separate containers coupled to a common chamber with gases and opening the respective containers with separate igniters.

Furthermore, in the gas generator 100 according to the present embodiment, the igniter 4 and the first communication part 40 are disposed facing each other. This makes it possible to release energy from the igniter 4 toward the first communication part 40 and more readily open the first communication part 40 upon actuation of the igniter 4.

Furthermore, in the gas generator 100 according to the present embodiment, the first communication part 40 and the second communication part 70 are disposed facing each other. This makes it possible to release energy from the opened first communication part 40 toward the second communication part 70 and more readily open the second communication part 70 upon actuation of the igniter 4.

Furthermore, in the gas generator 100 according to the present embodiment, the second communication part 70 and the discharge part 50 are disposed facing each other. This makes it possible to release energy from the opened second communication part 70 toward the discharge part 50 and more readily open the discharge part 50 upon actuation of the igniter 4.

Further, in the gas generator 100 according to the present embodiment, the igniter 4, the first communication part 40, the second communication part 70, and the discharge part 50 are disposed on an identical straight line. This makes it easy to open the first communication part 40, the second communication part 70, and the discharge part 50 all together by the energy released from the igniter 4 upon actuation of the igniter 4.

Furthermore, the outer shell housing 10 according to the present embodiment is formed in a bottomed tubular shape, and the igniter 4, the first communication part 40, the second communication part 70, and the discharge part 50 are disposed on a center axis A1 of the outer shell housing 10. This makes it possible to impart the gas generator 100 with an axisymmetric structure with respect to the center axis A1, facilitate manufacture of the gas generator 100, and suppress output unevenness of the gas generator 100 in a circumferential direction.

However, in the gas generator according to the present disclosure, the arrangement of the igniter, the first communication part, the second communication part, and the discharge part is not limited to the aspects described above, and need not be linear.

Further, the gas generator 100 according to the present embodiment further includes a diffuser housing 8 having a tubular shape, joined to the outer shell housing 10 at an end portion, and forming, inside the diffuser housing 8, a diffusion chamber S30 to be in communication with the gas filling chamber S20 through the discharge part 50, and a circumferential wall part 81 of the diffuser housing 8 is formed with a gas discharge hole 83 through which the diffusion chamber S30 and the outside of the gas generator 100 are in communication with each other. This makes it possible to mix and ignite the fuel gas and the oxidizing gas in the diffusion chamber S30. Further, the gas discharge hole 83 is formed in the circumferential wall part 81 of the diffuser housing 8, making it possible to change the flow of gas from the axial direction to the radial direction. Note that the diffuser housing 8 is not an essential component of the gas generator according to the present disclosure. The gas generator according to the present disclosure may be configured to mix and ignite the gas in a filling chamber.

Further, the fuel gas with which the gas generator 100 is filled according to the present embodiment is hydrogen gas, and a wall surface of one of the first filling chamber S1 and the second filling chamber S2, whichever is filled with the hydrogen gas (second filling chamber S2 in this example), is coated with a hydrogen-embrittlement resistant film C1. This makes it possible to prevent hydrogen-embrittlement of the metal surface constituting the wall surface of the second filling chamber S2 caused by contact with hydrogen.

Further, the second communication part 70 according to the present embodiment is formed as part of the second partition wall part 60, is configured to rupture by actuation of the igniter 4, and protrudes in a dome shape toward the second filling chamber S2. This suppresses at least deformation in a protruding shape toward the first filling chamber S1, thereby preventing repeated recessing and protruding deformations of the second communication part 70 when filled with pressurized gas. As a result, a strength of the second communication part 70 against the pressurized gas can be increased.

Furthermore, the second communication part 70 according to the present embodiment is formed thinner than other areas of the second partition wall part 60. This facilitates rupture of the second communication part 70 upon actuation of the igniter 4.

Furthermore, the second communication part 70 includes a fragile part 701 having a linear shape and formed thinner than other areas of the second communication part 70. This further facilitates rupture of the second communication part 70 upon actuation of the igniter 4.

Note that the second communication part of the gas generator according to the present disclosure need not be part of the second partition wall part. The second communication part may be formed by an opening formed in the second partition wall part, and a rupturable plate configured to close the opening before actuation of the igniter and rupture by actuation of the igniter.

Further, the first communication part 40 according to the present embodiment is formed by an opening 24 formed in the first partition wall part 30, and a first rupturable plate 6 configured to close the opening 24 before actuation of the igniter 4 and rupture by actuation of the igniter 4. This facilitates the opening of the first communication part 40 by actuation of the igniter 4. Note that the first communication part according to the present disclosure is not limited to the aspect described above, and may be formed as, for example, part of the first partition wall part and thus rupture by actuation of the igniter.

Further, the discharge part 50 according to the present embodiment is formed by an opening 14 formed in the outer shell housing 10 and a second rupturable plate 7 configured to close the opening 14 before actuation of the igniter 4 and rupture by actuation of the igniter 4. This makes it possible to open the discharge part 50 by actuation of the igniter 4. Note that the discharge part according to the present disclosure is not limited to the aspect described above, and may be formed as, for example, part of the outer shell housing and thus rupture by actuation of the igniter.

Note that the ignition unit according to the present disclosure may include a gas generating agent disposed in the ignition chamber and burned by actuation of the igniter. This makes it possible to increase the energy generated by actuation of the igniter. That is, this makes it possible to increase the energy for opening the first communication part, the second communication part, and the discharge part. For example, when the igniter, the first communication part, the second communication part, and the discharge part are not disposed on the same straight line and insufficiencies result with only the energy released from the igniter, the energy can be supplemented by arranging the gas generating agent in the ignition chamber.

Further, the first filling chamber S1 according to the present embodiment includes a first axial direction region S11 adjacent to the ignition chamber S10 in an axial direction of the outer shell housing 10 with the first partition wall part 30 interposed therebetween, and a first radial direction region S12 having a tubular shape surrounding the ignition chamber S10 from a radial direction of the outer shell housing 10 with the first partition wall part 30 interposed therebetween. Then, the second filling chamber S2 according to the present embodiment includes a second axial direction region S21 adjacent to the first axial direction region S11 of the first filling chamber S1 in the axial direction of the outer shell housing 10 with the second partition wall part 60 interposed therebetween, and a second radial direction region S22 having a tubular shape surrounding the first radial direction region S12 of the first filling chamber S1 from the radial direction of the outer shell housing 10 with the second partition wall part 60 interposed therebetween. The ignition chamber S10, the first axial direction region S11, and the second axial direction region S21 are aligned in this order from a lower side to an upper side in the axial direction. Further, the ignition chamber S10, the first radial direction region S12, and the second radial direction region S22 are aligned in this order from an inner side to an outer side in the radial direction. With the first filling chamber S1 including the first radial direction region S12 having a tubular shape, it is possible to shorten a length of the first filling chamber S1 in the axial direction while securing a volume for filling the gas. Similarly, with the second filling chamber S2 including the second radial direction region S22 having a tubular shape, it is possible to shorten a length of the second filling chamber S2 in the axial direction while securing a volume for filling the gas. As a result, a length of the gas generator 100 in the axial direction can be shortened and the gas generator 100 can be reduced in size. Further, in the gas generator 100 according to the embodiment, with the first communication part 40, the second communication part 70, and the discharge part 50 being disposed on the center axis A1 of the outer shell housing 10, by shortening the lengths of the first filling chamber S1 and the second filling chamber S2 in the axial direction, it is possible to shorten a distance between the first communication part 40 and the second communication part 70 and a distance between the second communication part 70 and the discharge part 50. This makes it possible to readily open the second communication part 70 and the discharge part 50 upon actuation of the igniter 4.

Here, as illustrated in FIG. 1, an outer shell container constituted by the outer shell housing 10 and the diffuser housing 8 is denoted as a gas generator housing 80. Then, a length in the axial direction and a width in the radial direction of the gas generator housing 80 are denoted as L1 and W1, respectively. The gas generator housing 80 of the gas generator 100 according to the present embodiment is formed in a short tubular shape, making the length L1 in the axial direction shorter than the width W1 in the radial direction. Accordingly, the gas generator 100 can be reduced in size.

### Other

While the embodiments of the technique according to the present disclosure have been described above, each aspect disclosed in the present specification can be combined with any other features disclosed in the present specification.

### REFERENCE SIGNS LIST

4 Igniter
6 First rupturable plate
7 Second rupturable plate
8 Diffuser housing
10 Outer shell housing
20 Ignition unit
30 First partition wall part
40 First communication part
50 Discharge part
60 Second partition wall part
70 Second communication part
80 Gas generator housing
100 Gas generator
C1 Hydrogen-embrittlement resistant film
S1 First filling chamber
S2 Second filling chamber
S10 Ignition chamber
S20 Gas filling chamber

1. A gas generator, comprising:
an outer shell housing;
an ignition unit including an igniter configured to release a combustion product by actuation;
a first partition wall part defining, inside the outer shell housing, an ignition chamber accommodating the ignition unit and a gas filling chamber filled with gas;
a first communication part provided in the first partition wall part and configured to be closed before actuation of the igniter and to open by actuation of the igniter and allow the ignition chamber and the gas filling chamber to be in communication with each other;
a discharge part provided in the outer shell housing and configured to be closed before actuation of the igniter and to open by actuation of the igniter and allow the gas filling chamber and an outside of the outer shell housing to be in communication with each other;
a second partition wall part defining, inside the gas filling chamber, a first filling chamber adjacent to the first communication part and a second filling chamber adjacent to the discharge part;
a fuel gas with which one of the first filling chamber and the second filling chamber is filled;
an oxidizing gas with which the other of the first filling chamber and the second filling chamber is filled; and
a second communication part provided in the second partition wall part and configured to be closed before actuation of the igniter and to open by actuation of the igniter and allow the first filling chamber and the second filling chamber to be in communication with each other.

2. The gas generator according to claim 1, wherein
the igniter and the first communication part are disposed facing each other.

3. The gas generator according to claim 1, wherein
the first communication part and the second communication part are disposed facing each other.

4. The gas generator according to claim 1, wherein
the second communication part and the discharge part are disposed facing each other.

5. The gas generator according to claim 1, wherein
the igniter, the first communication part, the second communication part, and the discharge part are disposed on an identical straight line.

6. The gas generator according to claim 5, wherein
the outer shell housing is formed in a bottomed tubular shape, and
the igniter, the first communication part, the second communication part, and the discharge part are disposed on a center axis of the outer shell housing.

7. The gas generator according to claim 1, further comprising:
a diffuser housing having a tubular shape, joined to the outer shell housing at an end portion, and forming, inside the diffuser housing, a diffusion chamber to be in communication with the gas filling chamber through the discharge part, wherein
a circumferential wall part of the diffuser housing is formed with a gas discharge hole through which the diffusion chamber and the outside of the gas generator are in communication with each other.

8. The gas generator according to claim 1, wherein
one of the first filling chamber and the second filling chamber is filled with the fuel gas together with an inert gas.

9. The gas generator according to claim 1, wherein
the fuel gas is hydrogen gas.

10. The gas generator according to claim 9, wherein
a wall surface of one of the first filling chamber and the second filling chamber, whichever is filled with the hydrogen gas, is coated with a hydrogen-embrittlement resistant film.

11. The gas generator according to claim 1, wherein
the other of the first filling chamber and the second filling chamber is filled with the oxidizing gas together with an inert gas.

12. The gas generator according to claim 1, wherein
the second communication part is formed as part of the second partition wall part, is configured to rupture by actuation of the igniter, and protrudes in a dome shape toward the second filling chamber.

13. The gas generator according to claim 12, wherein
the second communication part is formed thinner than another area of the second partition wall part.

14. The gas generator according to claim 13, wherein
the second communication part includes a fragile part having a linear shape and formed thinner than another area of the second communication part.

15. The gas generator according to claim 1, wherein
the ignition unit includes a gas generating agent disposed in the ignition chamber and burned by actuation of the igniter.

16. The gas generator according to claim 1, wherein
the first communication part is formed by an opening formed in the first partition wall part, and a rupturable plate configured to close the opening before actuation of the igniter and rupture by actuation of the igniter.

17. The gas generator according to claim 1, wherein
the discharge part is formed by an opening formed in the outer shell housing and a rupturable plate configured to close the opening before actuation of the igniter and rupture by actuation of the igniter.

18. The gas generator according to claim 1, wherein
the outer shell housing is formed in a bottomed tubular shape,
the first filling chamber includes,
a first axial direction region adjacent to the ignition chamber in an axial direction of the outer shell housing with the first partition wall part interposed between the first axial direction region and the ignition chamber, and
a first radial direction region having a tubular shape surrounding the ignition chamber from a radial direction of the outer shell housing with the first partition wall part interposed between the first radial direction region and the ignition chamber, and
the second filling chamber includes,
a second axial direction region adjacent to the first axial direction region of the first filling chamber in the axial direction of the outer shell housing with the second partition wall part interposed between the second axial direction region and the first axial direction region, and
a second radial direction region having a tubular shape surrounding the first radial direction region of the first filling chamber from the radial direction of the outer shell housing with the second partition wall part interposed between the second radial direction region and the first radial direction region.

19. The gas generator according to claim 18, further comprising:
a diffuser housing having a tubular shape, joined to the outer shell housing at an end portion, and forming, inside the diffuser housing, a diffusion chamber to be in communication with the gas filling chamber through the discharge part, wherein
a circumferential wall part of the diffuser housing is formed with a gas discharge hole through which the diffusion chamber and the outside of the gas generator are in communication with each other,
the diffusion chamber is adjacent to the gas filling chamber in the axial direction of the outer shell housing with a wall of the outer shell housing interposed between the diffusion chamber and the gas filling chamber, and
a gas generator housing constituted by the outer shell housing and the diffuser housing has a length in the axial direction shorter than a width in the radial direction.
